(19) United States
(12) Patent Application Publication
(10) Pub. No.: US 2009/0220652 A1
(43) Pub. Date: Sep. 3, 2009

(54) Meat Brines

(75) Inventors: Matthew A. Gardner, Witchita, KS (US); Alexander Patist, Shakopee, MN (US)

Correspondence Address: CARGILL, INCORPORATED, P.O. Box 5624, MINNEAPOLIS, MN, 55440-5624, US

(73) Assignee: Cargill Incorporated, Wayzata, MN (US)

(21) Appl. No.: 12/224,971

(22) PCT Filed: Mar. 15, 2007
(86) PCT No.: PCT/US2007/006455

§ 371 Date: Jan. 6, 2009

Related U.S. Application Data
(60) Provisional application No. 60/782,898, filed on Mar. 16, 2006.

(51) Int. Cl. A23L 1/318; A23L 3/30; A23B 4/02; A23L 1/314

(52) U.S. Cl. 426/92; 426/238; 426/652; 426/281

(57) ABSTRACT

Disclosed are methods for treating brine products with ultrasonic energy. The methods may be utilized to prepare a reduced viscosity brine product. The methods also may be used to prepare an enhanced meat product by combining a meat product with the reduced viscosity brine product.

### CROSS-REFERENCE TO RELATED APPLICATIONS

The present application claims the benefit of U.S. provisional patent application Ser. No. 60/782,898, filed on Mar. 16, 2006, which content is incorporated herein by reference in its entirety.

### FIELD

The present invention relates to meat brines. More specifically, the present invention relates to methods of treating a brine with ultrasonic energy prior to combining the brine with a fresh meat product. The present application includes subject matter related to U.S. provisional patent application Ser. No. 60/727,591, filed on Oct. 16, 2005; U.S. provisional patent application Ser. No. 60/750,477, filed on Dec. 15, 2005; international application no. PCT/US06/40233, filed on Oct. 16, 2006; and international application no. PCT/US06/47989, filed on Dec. 15, 2006; which contents are incorporated herein by reference in their entireties.

### BACKGROUND

Disclosed are methods for reducing viscosity of meat brines. Also disclosed are meat brine compositions having reduced viscosity.

Fresh meat (i.e., “raw meat”) may lose water from the time the meat is initially processed in a slaughterhouse, aged, transported, and displayed for retail purchase (collectively referred to herein as “storage”). Additional water loss may occur when the fresh meat is cooked for consumption.

Because water loss during storage or cooking may negatively impact the visual appeal or palatability of fresh meat, various approaches have been used to prevent water loss. One common approach for preventing water loss is to prepare “enhanced fresh meat” by combining fresh meat with an aqueous mixture, commonly referred to as brine, during initial meat processing. Enhanced fresh meat generally means fresh meat that have been treated with a brine. In addition to water, common ingredients used in conventional brines include salts (e.g., sodium chloride, potassium chloride, sodium phosphate, and the like), antioxidants and flavorings.

Conventional brines may increase the water content of meat cuts in several ways. For example, certain components in the brine such as salts may cause the swelling of myofibrils in the meat, which may result in better water retention in the enhanced meat. The brining process typically increases the weight of fresh meat cuts about five to fifteen percent. Although some of this water evaporates during cooking, the meat has a higher water content when cooking commences, and thus, the cooked meat may have a higher water content after cooking as compared to non-enhanced meat.

In addition, conventional brines may include components that influence the pH of meat to increase water retention. For example, phosphates may be used to increase the pH of the meat and thereby increase the number of positively charged sites for binding water in the meat. Depending on the amount and type of brine used, the brining process may reduce moisture loss during cooking to as little as fifteen percent.

One potential drawback of using conventional brines to enhance fresh meat cuts, particularly brines that influence the pH of the brine, is that the color of the enhanced fresh meat prior to cooking may be adversely affected. For example, conventionally enhanced fresh meat may darken in color (e.g., may exhibit brown and/or green colors on the surface of the meat) from the time the fresh meat is brined and displayed for retail purchase. Such darkening may make the enhanced fresh meat cut appear less desirable to consumers in a retail display setting. Additionally, fresh meat enhanced with conventional brines may possess an unnatural, processed texture after cooking, more commonly found in products like ham.

As an alternative to salts or in addition to salts, brines may include hydrocolloid ingredients or water binding agents such as gums, starches, gelatins, and the like, which are used in brines to increase the water binding properties of the enhanced meat. Because these types of ingredients are thickeners, the level of these ingredients that can be incorporated into brines is often limited by the viscosity of the final brine solution. The initial viscosity of a brine must be relatively low in order for the brine to be injected into meat or to enter meat during a tumbling process.

Therefore, there is a need in the art for methods and compositions for enhancing fresh meat that overcome one or more of these drawbacks.

### SUMMARY

Disclosed are methods for reducing viscosity of a brine product. The methods typically include subjecting the brine product to ultrasonic energy.

In some embodiments, the methods may include reducing the viscosity of a brine product while maintaining the brine product at a temperature of no more than about 20° C. (˜68° F.). In desirable embodiments, the methods may include reducing the viscosity of a brine product while maintaining the brine product at a temperature of no more than about 10° C. (˜50° F.) (or no more than about 4° C. (˜40° F.)). In some embodiments, the methods may include reducing the viscosity of a brine product while maintaining the brine product at a temperature between about 0-4° C. (about 32-40° F.), e.g., about 1° C. (34° F.).

The methods may include reducing the viscosity of a brine product by at least about 80% (or desirably 90%, or more desirably 95%), relative to the viscosity of the brine product prior to subjecting the brine product to ultrasonic energy. In some embodiments, the brine product has a viscosity of no more than about 2000 cPs (or desirably no more than 1000 cPs, or more desirably no more than 500 cPs, or even more desirably no more than 100 cPs) after the brine product has been subjected to ultrasonic energy and is at a selected temperature (e.g., about 4° C. (˜40° F.)).

The methods may include subjecting a brine product to ultrasound having any suitable energy for reducing the viscosity of the brine product. For example, the methods may include subjecting the brine product to about 1×10⁻⁴-1×10⁻¹ kilowatt-hour ultrasonic energy per liter brine product (or desirably 1×10⁻³-1×10⁻² kilowatt-hour ultrasonic energy per liter brine product).

The ultrasonic energy may have any suitable frequency for reducing the viscosity of a brine product. Typically, the ultrasonic energy has a frequency of about 15-100 kHz.

The brine may be treated for any suitably period of time to reduce the viscosity of the brine. In some embodiments, the brine product is subjected to ultrasonic energy for about 2-240 seconds (or desirably 2-120 seconds, or more desirably 4-60 seconds). The brine product may be treated with ultrasonic energy in batch methods, in continuous flow methods, or using a combination of both methods.

The ultrasonic energy may have any suitable power for reducing the viscosity of the brine product. In some embodiments, the brine product is subjected to ultrasonic energy having a power of about 0.2-20 kW. In other embodiments, the brined product is subjected to ultrasonic energy having a power of about 0.3-20 kW. In further embodiments, the brine product is subjected to ultrasonic energy having a power of about 0.4-15 kW.

In some embodiments, prior to the brine product being subject to ultrasonic energy, the brine product may have a viscosity of no less than about 5000 cPs (or 10000 cPs, or 20000 cPs) at a temperature of about 4° C. (˜40° F.).

The brine product typically includes a water binding agent (e.g., a hydrocolloid agent or a thickening agent). In some embodiments, the brine product may include a water binding agent at a concentration of about 0.1-10% (wt/wt) or of about 5-10% (wt/wt). Water binding agents include any agent that binds water and typically results in an increase in viscosity of the brine (i.e., causes the brine to thicken). Water binding agents may be derived from animal products or vegetable products. Water binding agents may be selected from, but are not limited to, protein products (e.g., gelatin products), carbohydrate polymer products (e.g., gums or starches), and mixtures thereof. In desirably embodiments, the water binding agent is a gelatin product.

Also disclosed are brine products having reduced viscosity. In some embodiments, the brine product include brine products prepared by the aforementioned methods and having a viscosity of no more than about 2000 cPs (desirably no more than 1000 cPs, more desirably no more than 500 cPs, or even more desirably no more than about 100 cPs) after the brine products have been treated with ultrasonic energy and are at a temperature of about 4° C. (˜40° F.).

The brine product may include salts, antioxidants and flavorings. For example, the brine product may include chloride salts (e.g., sodium chloride and potassium chloride) and phosphate salts (e.g., sodium phosphate). In some embodiments, the brine may be salt-free, (i.e., the brine product has a salt content of less than about 1 ppm). In further embodiments, the brine product may be phosphate-free (i.e., the brine product has a phosphate content of less than about 1 ppm).

Also disclosed are brine products having desirable rheologic properties. In some embodiments, the brine products include a water binding agent at a concentration of about 0.1-10% (wt/wt) (or optionally 5-10% (wt/wt)) and have a viscosity of no more than about 2000 cPs, after the brine product has been maintained at a temperature of no more than about 20° C. (˜68° F.) (or desirably, after the brine product has been maintained at a temperature of no more than about 10° C. (˜50° F.)). Typically, after the reduced viscosity product is cooled (e.g., to no more than about 4° C. (˜40° F.)), the viscosity of the reduced viscosity brine product increases (e.g., to no less than about 2000 cPs, desirably no less than about 5000 cPs, and even more desirably no less than about 10000 cPs).

Also disclosed are enhanced meat products. In some embodiment, the enhanced meat products are prepared by combining a meat product (e.g. fresh meat) with the aforementioned brine products (e.g., reduced viscosity brine products). The brine product and meat product may be combined by any suitable method to prepare the enhanced meat product, including injecting the reduced viscosity brine product into the meat product or tumbling the meat product and the reduced viscosity brine product. Typically, after the enhanced meat product is cooled (e.g., to no more than about 4° C. (˜40° F.)), the viscosity of the reduced viscosity brine product increases (e.g., to no less than about 2000 cPs, desirably no less than about 5000 cPs, and even more desirably no less than about 10000 cPs).

In some embodiments, the methods for preparing an enhanced meat product may include: (a) subjecting a brine product that comprises a water binding agent at a concentration of about 0.1-10% (wt/wt) (or optionally about 5-10% (wt/wt)) to ultrasonic energy to obtain a reduced viscosity brine product; and (b) combining the reduced viscosity brine product with a meat product (e.g., fresh meat) to obtain an enhanced meat product. In further embodiments, the reduced viscosity brine product is obtained while maintaining the brine product at a temperature of no more than about 20° C. (˜68° F.) (desirably while maintaining the brine product at a temperature of no more than about 2-10° C. (˜50° F.) (or no more than about 4° C. (˜40° F.)). In some embodiments, the methods may include reducing the viscosity of a brine product while maintaining the brine product at a temperature between about 0-4° C. (about 32-40° F.), e.g., about 1° C. (34° F.).

The reduced viscosity brine product may be combined with the meat product by any suitable method or combinations of methods. These may include, but are not limited to injecting the reduced viscosity brine product into the meat product and tumbling the reduced viscosity brine product together with the meat product.

### BRIEF DESCRIPTION OF THE DRAWING

FIG. 1. shows the viscosity of Brine 1 samples at 35, 40 and 45° F., as determined using a spindle S61.

FIG. 2 illustrates a chart summarizing the L* value of fresh meat cuts for one example of the present invention.

FIG. 3 illustrates a chart summarizing the a* value of fresh meat cuts for one example of the present invention.

FIG. 4 illustrates a chart summarizing the L* value of beef steaks for another example of the present invention.

FIG. 5 illustrates a chart summarizing the L* value of pork chops for another example of the present invention.

FIG. 6 illustrates a chart summarizing the a* value of beef steaks for another example of the present invention.

FIG. 7 illustrates a chart summarizing the a* value of pork chops for another example of the present invention.

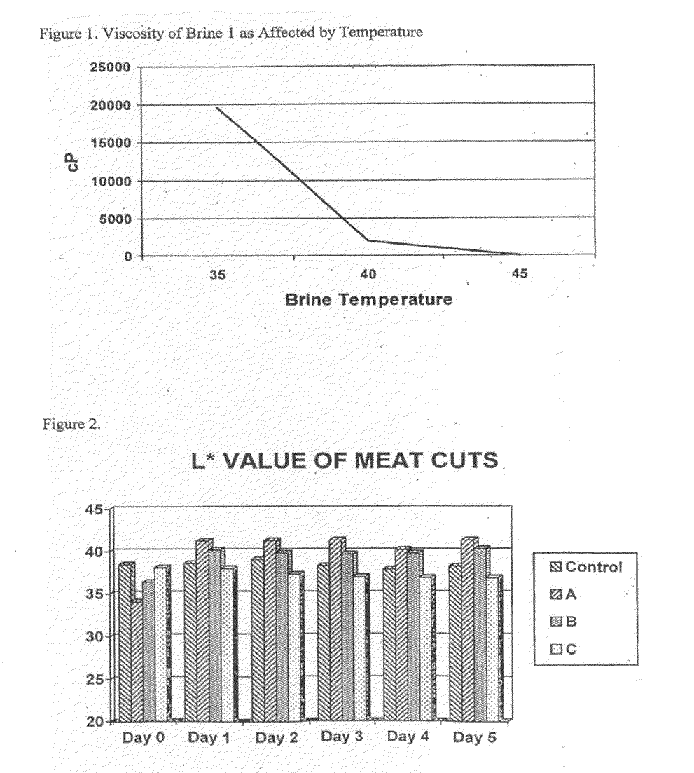

### DETAILED DESCRIPTION OF THE PREFERRED EMBODIMENTS

Disclosed are methods and compositions for enhancing fresh meat. As used herein, the phrase “fresh meat” (or “fresh meat cut”) refers to any type or cut of meat after slaughter and prior to cooking. For example, fresh meat may include, but are not limited to fresh; chilled, or frozen meat cuts. Suitable fresh meat cuts may be obtained from bovine, porcine, equine, caprine, ovine, avian animals, fish, or any animal commonly slaughtered for food production. Bovine animals include, but are not limited to buffalo, and all cattle, including steers, heifers, cows, and bulls. Porcine animals include, but are not limited to feeder pigs and breeding pigs, including sows, gilts, barrows, and boars. Ovine animals include, but are not limited to, sheep, including ewes, rams, wethers, and lambs. Poultry include, but are not limited to chicken, turkey, and ostrich. Although the following description is directed towards fresh beef cuts, embodiments of the present invention may be suitable for other types of fresh meat.

As used herein “brine” is an aqueous solution that is suitable for combining with fresh meat to impart the fresh meat with enhanced properties. In some embodiments, the brine product optionally includes a water binding agent at a selected concentration and water. The brine product optionally may include additional ingredients such as salts, flavorings, and preservatives.

“Water binding agents” include any agent that binds water and typically result in an increase in viscosity of the brine when dissolved in the brine. “Water binding agents” may be synthetic or naturally derived (e.g., animal-derived products or vegetable-derived products). “Water binding agents” may include “thickening agents” that are suitable as food additives (e.g., gelatin, agar, arabic gum, bentonite, carrageenan, ethylcellulose and carboxymethyl cellulose, polyethylene glycol, xanthan gum and the like). “Water binding agents” may include, but are not limited to protein proteins (e.g., gelatin products) and polymeric carbohydrate products (e.g., gums and starches such as vegetable starches). A suitable “Water binding agent” typically is capable of binding at least about 4 times its weight in water (or desirably at least about 6 times its weight in water, or more desirably at least about 8 times its weight in water, or even more desirably at least about 10 times its weight in water.)

Suitable gelatin products may include type A gelatin, which is obtained from acid-treated animal tissue, and type B gelatin, which is obtained from alkali-treated animal tissue. Gelatin products may also include gelatin that has been processed into a hydrolyzed form, in which the gelatin protein chains are further broken down. Suitable gelatin products may be capable of absorbing up to 10 times their weight in water.

Suitable gelatins for use in the brine products as described herein include type A gelatins, type B gelatins, hydrolyzed gelatins and combinations or derivatives thereof. Gelatin is widely available in either powder or flake form from a number of commercial sources. Examples of commercially available gelatins include Flavorlean 201-B™ and Flavex 95™ brand gelatins produced by Flavex Technologies, as well as gelatins available from Rousselot, PB and Knox companies. Commercially available gelatins may also contain minimal amounts of beef stock or other flavorings, preservatives and other additives.

The amount or concentration of gelatin in the brine product may vary widely depending on the particular type of fresh meat to be enhanced, the specific meat cut, the type of gelatin used, the expected storage time of the enhanced fresh meat and/or the anticipated cooking method. In some embodiments, the brine product includes about 0.1-10 wt. % gelatin or 0.5-10 wt. % gelatin. In other embodiments, the brine product includes about 0.75-5 wt. % gelatin. In still other embodiments, the brine product includes about 1-3 wt. % gelatin or 5-10 wt. % gelatin. The brine also may include about 50-99 wt. % water.

The brine product may include animal-derived products other than gelatin products or in addition to gelatin products. For example, the brine product may include animal products derived from extracting animal tissue (e.g., meat) with an alkali solution (e.g., a solution having a pH of at least about 9.0, or at least about 10.0, or at least about 11.0).

In some embodiments, the brine product may include gelatin but is substantially free of phosphates such as sodium phosphate and/or other polyphosphates. As used herein, “substantially free” mean having less than about 1 ppm. In other embodiments, the brine product includes less than about 3 wt. %, more particularly less than about 2 wt. % and more particularly less than about 1 wt. % phosphates. In further embodiments, the brine product is entirely free of phosphates (i.e., phosphate is not detectable in the brine product).

The brine product as disclosed herein may also include a variety of optional additives. Examples of suitable additives include salts, synthetic antioxidants, natural antioxidants such as rosemary, and bacterial and pathogen inhibitors such as sodium or potassium lactate. Flavoring may be included such as beef stock or similar stock materials, which may supplement the water content of the brine. In some embodiments, the brine product includes about 50-96 wt. % water, and may include one or more of the following ingredients: about 0.5-3 wt. % gelatin, about 0.5-1% wt. % antioxidants, about 0.2-0.5 wt. % beef stock; and about 1-2 wt. % salt.

In some examples, the brine product may include gelatin, water and optional additives, and includes less than about 2 wt. % phosphates (or desirably, is substantially free of phosphates, or even more desirably, is entirely free of phosphates). For example, the brine product may include about 0.1-10 wt. % gelatin (or about 0.5-10 wt. % gelatin) and about 50-99 wt % water. Optionally, the brine product includes additive selected from salts, lactates (e.g., sodium lactate or potassium lactate) or other antimicrobial agents, natural and synthetic antioxidants, and flavorings.

In some embodiments, the brine products may have a pH that is approximate to the pH of non-enhanced fresh meat (e.g., about 4.5-7.5, desirably about 5.0-7.0, or even more desirably about 5.2-6.8). The resulting fresh meat cuts enhanced with the brine products disclosed herein may have a pH that is similar to non-enhanced fresh meat cuts. Enhanced meat cuts as disclosed herein may exhibit improved color characteristics compared to fresh meat cuts enhanced with brines that more substantially influence the pH of the fresh meat cuts (e.g., brines having a pH <5 or >7). In other embodiments, the brine products may have a basic pH that is about 8.0-11.0, or desirably about 8.5-10.5, or even more desirably about 9.0-10.0. The pH of the brine product may be adjusted by adding suitable base agents (e.g., NaOH). The brine products may include suitable buffering agents for maintaining a desirable pH.

The brine products are prepared by adding the gelatin and other optional ingredients to a predetermined amount of water. The temperature of the water to which the gelatin is added may be adjusted to affect the dissolution and/or binding capabilities of the gelatin. Depending on the amount and type of gelatin added to the water, the temperature of the water at the time the gelatin is added may be about 4-100° C. In some embodiments, the water is heated to its boiling point and the gelatin is subsequently added. In other embodiments (e.g., embodiments in which the brine includes hydrolyzed gelatin), the water may be heated to a temperature less than about 100° C. (desirably less than about 80° C.; or more desirably less than about 60° C., or even more desirably less than about 40° C.). In some embodiments, the water used to prepare the brine is not heated or is heated only to room temperature (i.e., about 20° C.) prior to adding the gelatin.

The methods disclosed herein typically include subjecting a brine product to ultrasonic energy. As used herein, “ultrasonic energy” means mechanical, vibratory energy that operates at frequencies greater than audible sound. “Ultrasonic energy” has a frequency that is inaudible to the human ear, typically at least about 10 kHz, and more typically at least about 16 kHz or at least about 20 kHz. “Ultrasonic energy” imparted to a liquid is capable of generating compression waves in the liquid and causing cavitation. As disclosed herein, ultrasonic energy may be utilized to reduce the viscosity of brine products that include at least one water binding agent (i.e., thickening agent).

The method typically includes subjecting the brine product to about (1×10⁻⁴-1×10⁻¹) kilowatt-hour ultrasonic energy per liter brine product (i.e., joules per liter brine product). In some embodiments, the method includes subjecting the brine product to about (1×10⁻⁴-1×10⁻²) kilowatt-hour ultrasonic energy per liter brine product, or about (1×10⁻⁴-1×10⁻³) kilowatt-hour ultrasonic energy per liter brine product. Commercial systems typically allow the user to vary the power of the ultrasonic energy and the “hold time” for the sample, (i.e., the amount of time that the sample is exposed to the ultrasonic energy). The power and/or hold time may be inversely varied to administer a desirable amount of energy to a volume of the brine product. For example, the brine product may be subjected to ultrasonic energy having power P₁ for a hold time H₁. Alternatively, the brine product may be subject to ultrasonic energy having power P₂ for a hold time H₂, where P₁(H₁)=P₂(H₂). Typically, the ultrasonic energy may have a power that varies from about 0.2-20 kW, (or desirably 0.4-2.0 kW), and the liquid egg material is subjected to ultrasonic energy for about 5-120 seconds, (or desirably for about 10-90 or 15-60 seconds).

In the method, it may be desirable to maintain the brine product at a temperature of less than about 60° C. (140° F.) during ultrasonication. For example, the brine product may be maintained at a temperature of about 2-60° C. (˜36-140° F.) or 2-50° C. (˜36-122° F.) while the brine product is subjected to ultrasonic energy (or desirably about 2-45° C. (˜36-113° F.), more desirably 2-40° C. (˜36-104° F.) even more desirably about 2-35° C. (˜36-95° F.)). In some embodiments, the brine product is maintained at a relatively low temperature while the brine product is subjected to ultrasonic energy in order to prevent the brine product from being cooked (i.e., to prevent proteins in the brine product from becoming denatured).

The ultrasonic energy may have any suitable frequency. In some embodiments, the ultrasonic energy has a frequency of about 15-100 kHz, desirably about 16-50 kHz, even more desirably about 16-24 kHz. In addition, the ultrasonic energy may have any suitable power. For example, in some embodiments, the brine product is subjected to ultrasonic energy having a power of about 0.2-25 kW. In other embodiments, the brine product is subjected to ultrasonic energy having a power of about 0.3-20 kW. In further embodiments, the brine product is subject to ultrasonic energy having a power of about 0.4-15 kW.

The brine product may be subjected to ultrasonic energy for any suitable period of time. For example, the brine product may be subjected to ultrasonic energy for about 1-120 seconds. In some embodiments, the brine product is subjected to ultrasonic energy for at least about 10 seconds. In other embodiments, the brine product is subjected to ultrasonic energy for at least about 60 seconds (1 minute). In further embodiments, the brine product is subjected to ultrasonic energy for at least about 120 seconds (2 minutes). In some embodiments, the brine product is subjected to ultrasonic energy for no more than about 30 seconds, (or 20 seconds, or 10 seconds).

The method typically includes subjecting the brine product to about (1×10⁻⁴-1×10⁻¹) kilowatt-hour ultrasonic energy per volume brine product (i.e., joules per liter brine product). In some embodiments, the method includes subjecting the brine product to about (1×10⁻⁴-1×10⁻²) kilowatt-hour ultrasonic energy per volume brine product, or about (1×10⁻⁴-1×10⁻³) kilowatt-hour ultrasonic energy per volume brine product. Commercial systems typically allow the user to vary the power of the ultrasonic energy and the “hold time” for the sample, (i.e., the amount of time that the sample is exposed to the ultrasonic energy). The power and/or hold time may be inversely varied to administer a desirable amount of energy to a volume of the brine product. For example, the brine product may be subjected to ultrasonic energy having power P₁ for a hold time H₁. Alternatively, the brine product may be subjected to ultrasonic energy having power P₂ for a hold time H₂, where P₁(H₁)=P₂(H₂). Typically, the ultrasonic energy may have a power that varies from about 0.2-20 kW, (or desirably 0.4-2.0 kW), and the brine product is subjected to ultrasonic energy for about 5-120 seconds, (or suitably for about 10-90 or 15-60 seconds). Power, frequency, energy, and time period may be varied to obtain a suitable product. Ultrasonic processors are known in the art and permit variation with respect to the ultrasonic energy that the produce.

Systems for generating ultrasonic energy are available from commercial sources (e.g., Hielscher GmbH, Teltow, Del.). The ultrasonic energy generated by these systems typically has a frequency of about 15-100 kHz. In some embodiments, the ultrasonic energy has a frequency of about 20-50 kHz. Systems may be devised that include transducer which provide discrete power units (e.g., 1 kW, 2 kW, 4 kW, 8 kW, 16 kW, or combinations and/or multiples thereof). Generally, these systems utilize one of two types of probes for administering ultrasonic energy (i.e., “sonotrodes”). These include axial probes (e.g., block sonotrodes) and radial probes (e.g., cascade sonotrodes), either of which are suitable for the method described herein. Suitable probes for the methods disclosed herein may include axial or radial probes.

The methods may include reducing the viscosity of a brine product by at least about 80% (or desirably 90%, or more desirably 95%), relative to the viscosity of the brine product prior to subjecting the brine product to ultrasonic energy. Because viscosity is reduced as the temperature of the brine is increased, typically a relative reduction in viscosity will be measured at a selected temperature (e.g., about 4° C. (˜40° F.) or about 7° C. (˜45° F.), or about 10° C. (˜50° F.) or about 20° C. (˜68° F.)). In some embodiments, the brine product has a viscosity of no more than about 2000 cPs (or desirably no more than 1000 cPs, or more desirably no more than 500 cPs, or even more desirably no more than 100 cPs) after the brine product has been subjected to ultrasonic energy and is at a selected temperature (e.g., about 4° C. (˜40° F.) or about 7° C. (˜45° F.), or about 110° C. (˜50° F.) or about 20° C. (˜68° F.)).

The viscosity of the reduced viscosity brine product typically will increase when the reduced viscosity brine product is cooled (e.g., to a temperature of no more than about 4° C. (˜40° F.) or about 2° C. (˜35° F.)). In some embodiments, the rate of increase in viscosity of the reduced viscosity brine product at a given temperature is reduced relative to the rate of increase in viscosity of a brine product that has not been subjected to ultrasonic energy.

After the brine product is subjected to ultrasonic energy, the brine product may be combined with a meat product to prepare an enhanced meat product. In one embodiment, the methods disclosed herein may be used to prepare an enhanced fresh meat product including about 0.05-2 wt. % gelatin dispersed throughout a fresh meat cut. The enhanced fresh meat product may also be substantially or entirely free of phosphates and may have a pH of about 5-7.

In a further embodiment, the methods disclosed herein may be used to enhance a fresh meat cut by preparing a brine product, which contains gelatin and water and which is substantially or entirely free of phosphates. The brine product is treated with ultrasonic energy and subsequently is dispersed into the fresh meat cut at a temperature of about 0-20° C. (˜30-70° F.) (e.g., about 2-7° C. (˜35-45° F.). The fresh meat cut may be enhanced with a sufficient amount of the brine product to increase the weight of the fresh meat cut by about 5-20 wt. %.

The methods for preparing enhanced meat as disclosed herein may utilize any method for combining fresh meat and a brine product. For example, fresh meat cuts may be enhanced with the brine products by dispersing the brine products throughout the fresh meat cuts. Suitable methods for enhancing the fresh meat cuts with brines include injecting, pumping, spraying, soaking, dipping or otherwise dispersing the brine products into or throughout the fresh meat cuts. In addition to the foregoing methods, the fresh meat cuts may be tumbled, kneaded, massaged or otherwise manipulated to further disperse the brine throughout the fresh meat cuts.

In some embodiments, the brine products are injected under pressure into a fresh meat cut as part of an automated commercial meat production step. Suitable injectors may be set to pump a particular volume of the brine into each fresh meat cut. An example of a commercially available brine injector/pump is the Schroder IMAX 630 available from Wolf-Tech, Kingston, N.Y.

The fresh meat cuts may be injected or otherwise enhanced with a sufficient amount of the brine product to cause a weight increase of about 5-20%, and more particularly about 10-15%. The actual amount of brine dispersed within the fresh meat and/or the weight gain of the fresh meat cut will vary depending on the method of enhancing the fresh meat cut, the type of meat, the particular meat cut and/or the particular brine product used. In one embodiment, the concentration of the brine product and the amount of brine dispersed into the fresh meat cut is controlled such that the enhanced fresh meat cut includes about 0.05-2 wt. % gelatin immediately after enhancement. In other embodiments, the concentration of the gelatin in the enhanced fresh meat cut is about 0.7-1 wt. % immediately after the brine is pumped into the fresh meat cut.

Prior to dispersing the brine product into the fresh meat cuts, the brine product is subject to ultrasonic energy. After being subject to ultrasonic energy, the brine product may be maintained at a sufficient temperature to prevent gelatin in the brine product from setting (i.e., converting to a gel-like state). The temperature at which the gelatin sets depends on the type of gelatin used and the concentration of the gelatin in the brine product. In some embodiments, the temperature of the brine product is maintained at a range of about 0-20° C. (˜30-70° F.) (optionally about 2-20° C. (˜40-70° F.)). In other embodiments, the temperature of the brine is maintained at about 2-5° C. (˜35-42° F.). In one embodiment, the temperature of the brine mixture may be maintained at a range between about −4-21° C. (˜25-70° F.) during injection. In other embodiments, the temperature of the brine is maintained between about ˜3-6° C. (˜27-42° F.) during injection.

After enhancing the fresh meat cut with the brine product, the temperature of the enhanced fresh meat cut is reduced to a temperature sufficient to cause any gelatin dispersed in the meat to set. For example, the temperature of the enhanced fresh meat cut may be reduced to about 0-2° C. (˜32-36° F.). In some embodiments, the enhanced fresh meat cut is vacuum-sealed in a bag or similar container, which is then placed in cold water to reduce the temperature of the enhanced fresh meat cut.

As indicated in the examples set forth below, the brine products of the present invention may be particularly useful for dispersing in fresh meats cuts and limiting the water loss of fresh meat cuts prior to cooking and during retail display. Such enhanced meat cuts may possess higher total water content when cooking commences, which may result in a higher water content remaining after cooking meat even if normal water loss occurs during cooking. The coloration of such fresh meat cuts may also be retained for a longer period of time up to and during retail display, such that the meat cuts have a more desirable appearance for a longer retail display time.

The methods disclosed herein may be used to prepare “food grade” enhanced meat products. “Food grade” means that up to specified amount of the specified agent can be ingested by a human without gerierally causing deleterious health effects. Examples of food grade agents include those additives “generally recognized as safe” (“GRAS”) by the United States Food and Drug Administration (“FDA”) and colorants approved by the FDA for use in foods for human consumption. In particular, food grade additives includes those compounds (or mixtures of compounds) listed as approved under 21 C.F.R. § § 73, 74, 172, 182 and 184 as well as other compounds recognized by comparable regulatory authorities in other countries. As used herein, “meat product” describes a protein-containing product. In some embodiments, the “meat product” may be suitable for human consumption as meat because it may contain a suitable amount of protein.

### EXAMPLES

### Example 1

Ultrasonic treatment was utilized to reduce the viscosity of brine solutions. A 400 watt Dr. Hielscher (Berlin, Germany) radial ultrasound probe was used for the testing.

Two different brines were prepared according to Table 1.

TABLE 1
Brines used during testing

| Ingredient | Brine 1 | Brine 2 |
|---|---|---|
| Water | 96.995% | 96.220% |
| Salt | 1.400% | 1.400% |
| Rosemary | 0.467% | 0.467% |
| Beef Stock | 0.373% | 0.373% |
| Rousselot 200 bloom gelatin | 0.770% | 1.540% |

For Brine 1, samples of the final mixture were chilled to 45, 40, 35° F. For Brine 2, samples were chilled to 60 and 50° F. A viscosity measurement was taken of each sample at each given endpoint temperature. Viscosity was measured with a Brookfield DV-E viscometer using spindles S61 and S63. The spindle used, RPM's, % torque and viscosity (cP) were all recorded.

Samples (150 mL) were subjected to ultrasound treatment with the axial probe at a 100% amplitude setting for various times (10, 20, 60 and 120 seconds). Temperature rise in the samples was limited by immersing samples in an ice water bath during treatment. Following treatment, temperature of each sample was recorded and the samples were chilled to their starting temperature. Once samples returned to the original temperature another viscosity measurement was taken to compare viscosity before and after treatment at the same temperature.

Brine 1 samples were subjected to high power ultrasound treatments for lengths of 10, 60 and 120 seconds. Treatment for 10 seconds was sufficient to reduce a viscous brine at 35° F. into a fluid one that was suitable for injecting into fresh meat cuts.

For any duration of ultrasound treatment, all of the samples from Brine 1 had a viscosity similar to non-treated samples (at 35° F.), when the samples were allowed to chill to 35° F. When the 40° F. samples were treated for either 60 or 120 seconds, the viscosity upon chilling back to 400 was much lower (˜8 cPs vs. 1908 cPs) than non-treated samples.

Similar results were observed in samples from Brine 2. However, Brine 2 samples had a viscosity of 144,000 cPs at 50° F. and 200,000 cPs at 35° F. After a 20 second ultrasound treatment, the samples from Brine 2 were fluid enough to inject.

### Example 2

Three USDA Select grade boneless strip loins were aged for eight days and cut into one-inch steaks. Steaks were alternately assigned to three groups, Sample Group A, Sample Group B, and a Control Group. Seven additional USDA Select grade boneless strip loins were divided into several large steaks, which were aged for two days from fabrication and labeled as Sample Group C.

Meat samples from Sample Groups A, B, and C were injected with corresponding brine mixtures A, B, and C identified in Table 2. The Control Group was not injected with a brine. Brine mixtures A, B, and C were prepared by combining each of the brine ingredients under agitation to form a generally uniform mixture.

TABLE 2

| | Brine Mixtures (weight percent) | | |
|---|---|---|---|
| Ingredients | A | B | C |
| Water | 95.86 | 95.50 | 96.425 |
| Salt | 1.65 | 1.65 | 1.815 |
| Beef Stock | | 0.44 | 0.44 |
| Rosemary | 0.55 | 0.55 | 0.55 |
| Flavorlean 201-B | 1.94 | | |
| Flavex 95 | | 1.86 | |
| Knox Gelatin | | | 0.77 |

As used in Table 2, the salt was a high-grade form of a 99.9 percent sodium chloride solution. The beef stock was an anhydrous form. The rosemary was an aqueous solution. Flavorlean 201-B is a combination of gelatin hydrosylate and beef stock available from Flavex. Flavex 95 is a gelatin hydrosylate material also available from Flavex. Knox brand gelatin is available from Kraft Foods.

Before and after injection, each meat cut was weighed to determine weight gain due to the brine injection. Meat cuts from Sample Groups A, B, and C were injected with the corresponding brine mixtures A, B, and C using a N-40 injector from Schroder Maschinenbau KG. The injector was set to pump sufficient brine into the meat cuts to raise the weight of the meat cuts by approximately 10 percent. Meat cuts from Sample Groups A and B were injected with the corresponding brines A and B at approximately 38° F. Meat cuts in Sample Group C were injected with brine C at 42° F. Variation in injection levels occurred because each meat cut accepted brine differently.

Following brine injection, the meat cuts from Sample Groups A and B were placed in retail meat trays, which were then over-wrapped in an oxygen permeable film. The trays were placed in a retail case at a temperature of 36° F. for five days. Each fresh meat sample was then cooked to an internal temperature of 145° F.

Meat cuts from Sample Group C were placed in a vacuum-package after injection, and the package was placed in an ice water bath for approximately 10 minutes to aid gel formation in the meat. The meat cuts were then held for 7 days in a 34° F. cooler. At the end of this time, two one-inch cuts were removed from the larger steaks and placed in a retail tray over-wrapped with an oxygen permeable film and monitored under the conditions described for Samples A and B. Meat characteristics were then evaluated for each Sample Group.

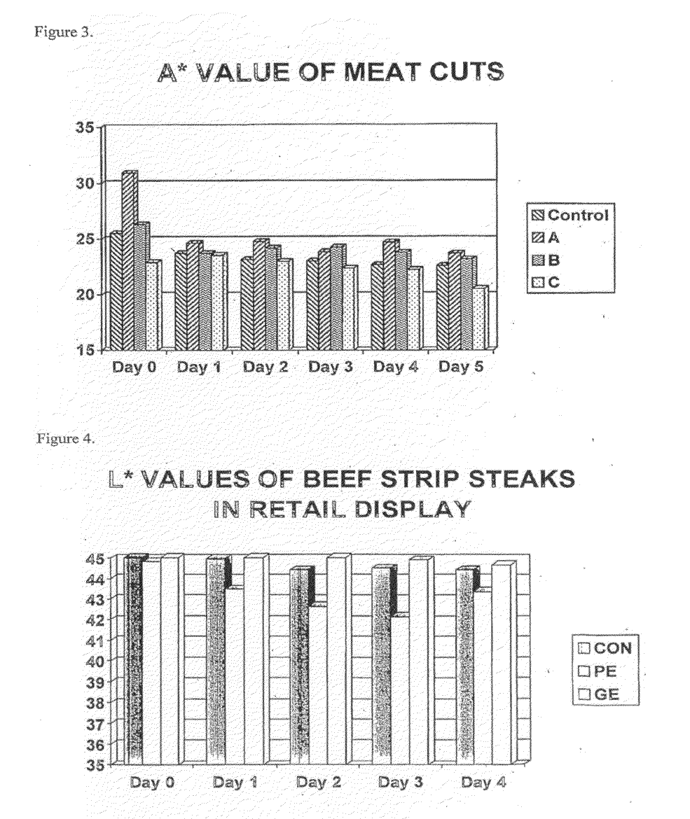

The average brightness (“L* value”) and the redness (“a* value”) of meat cuts in each Sample Group were measured using a HunterLab Miniscan spectophotometer available from Hunter Associates Laboratory, Inc. Reston, Va. The scale for the L* values ranges from zero (pure black) to 100 (pure white). Thus, as the L* values increase, the color of the meat sample appears lighter. In the case of the a* values, the more positive the a* values, the redder the sample and the more negative the a* value, the greener the sample. The results of the brightness and redness tests are set forth in FIGS. 2 and 3, respectively.

The results indicate that Sample Groups A and B retained similar, and in some cases better, brightness characteristics and similar color characteristics over the five-day period compared to the Control Group. Percent retail drip loss for Sample Groups A and B was measured by comparing the weight of each fresh meat cut from these Sample Groups immediately after brining to the weight of the same fresh meat sample after being stored for five days in the retail display case. Percent cook loss was measured by comparing the weight of each fresh meat sample after being stored for five days in the retail display case with the weight of the same sample after cooking. Percent total loss was measured by comparing the green start weight (pre-brining) weight of each fresh meat cut with the weight of the same meat cut after cooking.

TABLE 3

| | Sample Groups | | |
|---|---|---|---|
| | Control | A | B |
| Retail drip loss % | 1.84 | 3.86 | 3.83 |
| Cook Loss % | 17.62 | 19.19 | 20.29 |
| Total Loss % | 19.15 | 13.14 | 12.46 |

The results set forth in Table 3 indicate that Sample Groups A and B exhibited less total loss than the Control Group. Taken together, the results of Table 3 indicate that Sample Groups A and B had higher water content after cooking than the Control Group.

For Sample Group C, purge loss was calculated by comparing the weight of the steaks immediately after injection to the weight of the steaks after seven days of storage in the vacuum package. Retail drip loss was measured by comparing the weight of the meat cuts removed from the steak after removal from the vacuum package to the weight of the cuts after five days in retail display. Results are set forth in Table 4 below.

TABLE 4

| | Sample Group C |
|---|---|
| 7 day purge loss % | 2.07 |
| Retail drip loss % | 1.79 |
| Cook Loss % | 22.84 |

Table 5 below shows the average pH of the meat cuts in Samples Groups A and B as well as the Control Group.

TABLE 5

| | Sample Groups | | |
|---|---|---|---|
| | Control | A | B |
| pH | 5.50 | 5.55 | 5.53 |

The results set forth in Table 5 indicate that Sample A and B had similar pH levels to the Control Group.

### Example 3

In a second example, the water-binding properties, color, and eating characteristics of fresh meat product enhanced with a gelatin based brine solution was analyzed. The goal of this test was to determine whether flavor, color and texture of a fresh meat product can be improved by application of a gelatin based brine solution without affecting the tenderness, juiciness and shelf-life of the product.

Twelve USDA Select boneless beef strip loins, aged seventeen days from fabrication, were cut into one-third sections. Similarly, twelve boneless pork loins, aged seven days from fabrication, were also cut into one-third sections. Each of the beef and pork sections were assigned to the following enhancement protocols:
1. Non-enhanced (CON)
2. Phosphate enhanced (PE)
3. Gelatin enhanced (GE)

Table 6 lists the brine ingredients for the phosphate and gelatin enhanced treatments. The gelatin was 225 Bloom, Type B, from Rousselot, the beef stock was from Proliant Ingredients, #1301, and the sodium phosphate was in anhydrous form. Each brine treatment was made by dissolving the ingredients in hot water.

TABLE 6

a) Brine Treatments

| | PE | GE |
|---|---|---|
| Water | 92.168% | 96.590% |
| Salt | 3.300% | 1.650% |
| 1. Sodium phosphate | 3.850% | |
| Beef Stock | 0.682% | 0.715% |
| Gelatin | | 1.045% |

Each fresh meat section was injected with a target pump level of 10.0% using a Schröder IMAX 520 from Wolf-Tech, Kingston, N.Y. Injection samples were weighed before and after injection to determine the increase in weight for each sample.

Following injection, the non-enhanced samples and the phosphate enhanced samples were put in Cryovac® bags and vacuum packaged. The gelatin enhanced samples were put in Cryovac® bags and then placed in an ice water bath for approximately ten minutes before being vacuum packaged in order to aid gel formation in the meat. All samples were thereafter held for six days in a 34° F. cooler. At the end of this time, one-inch steaks and pork chops were cut from the beef and pork sections.

Two pieces of meat from each beef and pork group, enhanced with the phosphate or gelatin brines, were placed in a retail tray and overwrapped in an oxygen permeable film. The retail trays containing the steaks were placed in the retail case and were monitored for color over four days at a case display temperature of approximately 36° F.

Two additional steaks and two additional pork chops were used for slice shear force tenderness testing. In order to complete the tenderness testing, the steaks and pork chops were first cooked to an internal temperature of 160° F. A slice parallel to the muscle fibers was then removed from the end of each piece of meat and placed in a texture analyzer. (TA.XT Plus, Texture Technologies Corp.) The texture analyzer measured the force to cut the steak and pork chops perpendicular to the muscle fibers. Cook loss on each steak and pork chop was also calculated using the before and after cooking weights of each steak and pork chop.

Table 7 shows the average pump levels (weight gain) attained for each treatment group. The pump levels were more consistent for the beef samples as opposed to the pork samples, but are both within acceptable ranges. Table 8 illustrates the water holding capacity as measured for each treatment group. As shown, the treated fresh meat samples in general lost more water during the purge, drip loss, and cook loss testing. However, because of the higher water content the final cooked product retained more water overall. Table 9 illustrates the slice shear force testing. The shear force to cut the beef samples was slightly higher for the gelatin enhanced brine in comparison to the non-enhanced and phosphate enhanced brine samples. The shear force to cut the pork chops was greatest for the control, least for the phosphate enhanced samples, and in the middle for the gelatin enhanced sample.

TABLE 7

| Brine Treatments | |
|---|---|
| Beef | Pork |

| | PE | GE | PE | GE |
|---|---|---|---|---|
| Pump level % | 10.04 | 9.99 | 11.90 | 9.45 |

TABLE 8

| | Brine Treatments | | | | | |
|---|---|---|---|---|---|---|
| | Beef | | | Pork | | |
| | CON | PE | GE | CON | PE | GE |
| 6 day purge | 2.53 | 3.86 | 5.59 | 3.07 | 1.76 | 4.00 |
| loss % | | | | | | |
| Retail drip | 2.42 | 2.80 | 3.09 | 2.61 | 2.93 | 4.07 |
| loss % | | | | | | |
| Cook Loss % | 13.88 | 12.25 | 14.68 | 14.33 | 13.91 | 15.69 |

TABLE 9

| | Brine Treatments | | | | | |
|---|---|---|---|---|---|---|
| | Beef | | | Pork | | |
| | CON | PE | GE | CON | PE | GE |
| Slice Shear | 13.97 | 12.04 | 14.39 | 11.92 | 8.40 | 10.46 |
| Force (kg) | | | | | | |

One beef steak each from the control group and the gelatin treated group was cooked to an internal temperature of 160° F. and cut into one-inch cubes for sensory testing. Panelists evaluated a sample from each treatment group on tenderness, juiciness, flavor and overall acceptability. The taste panel included approximately 29 randomly selected workers at the testing facility who had no formalized training. Table 10 illustrates the sensory characteristics for the treatment groups. The pork was not analyzed in this manner.

TABLE 10

Brine Treatments

| | CON | GE |
|---|---|---|
| Tenderness^{a} | 6.09 | 6.37 |
| Juiciness^{b} | 5.74 | 6.48 |
| Beef Flavor^{c} | 5.16 | 5.71 |
| Overall acceptability^{d} | 5.59 | 6.51 |

^{a}Evaluated on a 10 point scale (0 = tough, 10 = tender)
^{b}Evaluated on a 10 point scale (0 = dry, 10 = juicy)
^{c}Evaluated on a 10 point scale (0 = dislike extremely, 10 = like extremely)
^{d}Evaluated on a 10 point scale (0 = dislike extremely, 10 = like extremely)

As is illustrated in Table 10, the gelatin brine enhanced beef had increased sensory characteristics for all of the testing categories as compared to the non-enhanced beef.

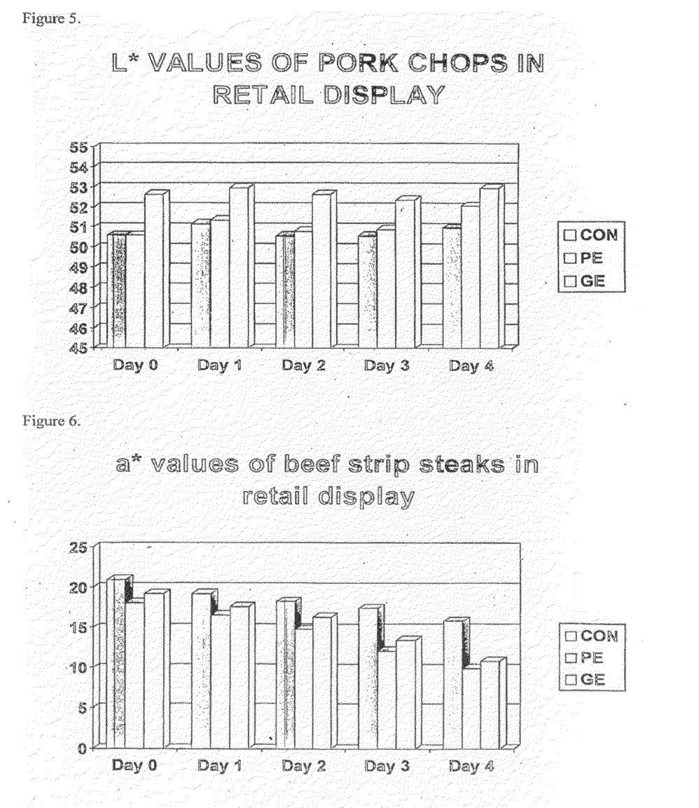

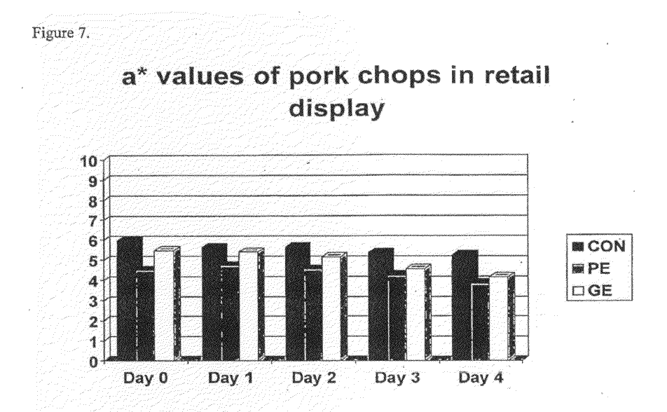

In addition, the average brightness and the redness of both the beef and pork meat cuts in each sample group were measured using a Minolta spectrophotometer. FIGS. 4 and 5 illustrate that the beef and pork treated with the gelatin enhanced brine retained a lighter color as compared to the phosphate enhanced meat and retained similar, and in some cases better, brightness characteristics than the non-enhanced meat. Moreover, as shown in FIGS. 6 and 7, both the beef and pork treated with gelatin enhanced brine retained a greater a* value throughout the testing period as compared to the phosphate enhanced meat. The a* values for the gelatin enhanced meat cuts were closer to the non-enhanced meat for both the beef and the pork and mean that the meat was more red in color.

It was therefore found that adding gelatin to the brine solution before injection into a fresh meat product increased the amount of water retained in the meat after vacuum packaging and packaging in a retail display tray as compared to non-enhanced meat. In addition, the cooked fresh meat beef had improved sensory characteristics. Unlike phosphate, gelatin does not act on the proteins in meat to bind water but is a water binder itself. This may result in improved meat texture compared to phosphate enhanced fresh meat. Finally, the gelatin enhanced fresh meat had improved color characteristics over phosphate enhanced meat such that the color and brightness more resembled non-enhanced fresh meat.

### Example 4

The brines of Example 2 are prepared and treated with ultrasound as in Example 1. The treated brines are combined with meat cuts as in Example 2.

### Example 5

The brines of Example 3 are prepared and treated with ultrasound as in Example 1. The treated brines are combined with meat cuts as in Example 3.

The above-detailed embodiments and examples are intended to be illustrative, not exhaustive, and those skilled in the art will recognize that various equivalent modifications are possible within the scope of the invention. For example, whereas steps are presented in a given order, alternative embodiments may perform steps in a different order. The various embodiments described herein can be combined to provide further embodiments. Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

It will be readily apparent to one skilled in the art that varying substitutions and modifications may be made to the invention disclosed herein without departing from the scope and spirit of the invention. The invention illustratively described herein suitably may be practiced in the absence of any element or elements, limitation or limitations which is not specifically disclosed herein. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention. Thus, it should be understood that although the present invention has been illustrated by specific embodiments and optional features, modification and/or variation of the concepts herein disclosed may be resorted to by those skilled in the art, and that such modifications and variations are considered to be within the scope of this invention.

In addition, where features or aspects of the invention are described in terms of Markush groups or other grouping of alternatives, those skilled in the art will recognize that the invention is also thereby described in terms of any individual member, any subgroup of members of the Markush group or other group, or the totality of members of the Markush group or other group.

Also, unless indicated to the contrary, where various numerical values are provided for embodiments, additional embodiments are described by taking any 2 different values as the endpoints of a range. Such ranges are also within the scope of the described invention.

1. A method for reducing viscosity of a brine product for meat comprising subjecting the brine product to ultrasonic energy.

2. The method of claim 1, wherein the viscosity of the brine product is reduced while maintaining the brine product at a temperature of no more than about 4° C. (˜40° F.).

3. The method of claim 1, wherein the viscosity of the brine product is reduced by at least about 80%, relative to the viscosity of the brine product prior to subjecting the brine product to ultrasonic energy.

4. The method of claim 1, wherein the brine product has a viscosity of no more than about 2000 cPs after subjecting the brine product to ultrasonic energy and the brine product is at a temperature of about 4° C. (˜40° F.).

5. The method of claim 1, wherein the brine product is subjected to about 1×10⁻⁴-1×10⁻¹ kilowatt-hour ultrasonic energy per liter brine product.

6. The method of claim 1, wherein the ultrasonic energy has a frequency of about 15-100 kHz.

7. The method of claim 1, wherein the brine product is subjected to ultrasonic energy for about 2-240 seconds.

8. The method of claim 1, wherein the brine product is subjected to ultrasonic energy having a power of about 0.2-20 kW.

9. The method of claim 1, wherein prior to subjecting the brine product to ultrasonic energy the brine product has a viscosity of no less than about 5000 cPs at a temperature of about 4° C. (˜40° F.).

10. The method of claim 1, wherein the brine product comprises a water binding agent at a concentration of about 0.1-10% (wt/wt).

11. (canceled)

12. The method of claim 10, wherein the water binding agent is selected from the group consisting of a protein product, a carbohydrate polymer product, and mixtures thereof.

13. The method of claim 10, wherein the water binding agent comprises a gelatin product.

14. A brine product prepared by the method of claim 1 having a viscosity of no more than about 2000 cPs at a temperature of about 4° C. (˜40° F.).

15. (canceled)

16. An enhanced meat product prepared by combining the brine product of claim 14 with a meat product.

17. (canceled)

18. The enhanced meat product of claim 16, wherein the reduced viscosity brine product is free of phosphates.

19. A brine product comprising a water binding agent at a concentration of about 0.1-10% (wt/wt) and having a viscosity of no more than about 2000 cPs, wherein the brine product has been maintained at a temperature of no more than about 4° C. (˜40° F.).

20. A method for preparing an enhanced meat product comprising:
(a) subjecting a brine product that comprises a water binding agent at a concentration of about 0.1-10% (wt/wt) to ultrasonic energy to obtain a reduced viscosity brine product; and
(b) combining the reduced viscosity brine product with a meat product.

21. The method of claim 20, wherein the meat product comprises a fresh meat product.

22. (canceled)

23. The method of claim 20, further comprising cooling the enhanced meat product to a temperature of no more than about 4° C. (˜40° F.), wherein the viscosity of the reduced brine product increases upon cooling.

24. The method of claim 20, wherein combining comprises at least one of injecting the reduced viscosity brine product into the meat product and tumbling the reduced viscosity brine product together with the meat product.
